(19) United States
(12) Patent Application Publication
(10) Pub. No.: US 2004/0145165 A1
(43) Pub. Date: Jul. 29, 2004

(54) Air bag deployment control system

(75) Inventors: Makoto Nagai, Saitama (JP); Toyohiko Shindo, Saitama (JP); Mikihito Kojima, Saitama (JP)

Correspondence Address: CARRIER BLACKMAN AND ASSOCIATES, 24101 NOVI ROAD, SUITE 100, NOVI, MI, 48375

(73) Assignee: Honda Giken Kogyo Kabushiki Kaisha, Tokyo (JP)

(21) Appl. No.: 10/614,681

(22) Filed: Jul. 7, 2003

(30) Foreign Application Priority Data
Jul. 8, 2002 (JP) 2002-198176

(51) Int. Cl. B60R 21/32

(52) U.S. Cl. 280/735; 180/273

(57) ABSTRACT

An air bag deployment control system, comprises a weight sensor which detects weight of an occupant sitting on a seat of a vehicle, and a controller which switches between deployment and non-deployment modes of an air bag based on the occupant weight detected by the weight sensor. The controller switches to the deployment mode permitting deployment of the air bag when the detected weight of the occupant is equal to or larger than a first threshold value, and switches to the non-deployment mode prohibiting deployment of the air bag when the detected weight of the occupant is smaller than a second threshold value. The second threshold value for switching from the deployment mode to the non-deployment mode is set smaller than the first threshold value for switching from the non-deployment mode to the deployment mode.

### BACKGROUND OF THE INVENTION

1. Field of the Invention

The present invention relates to an air bag deployment control system in which a weight of an occupant sitting on a seat of a vehicle is detected by a weight sensor, and the system switches between different control modes depending on the weight detected, including a deployment mode for permitting deployment of an air bag when the detected weight of the occupant is equal to or larger than one threshold value, and a non-deployment mode for prohibiting deployment of the air bag when the detected weight of the occupant is smaller than another threshold value.

2. Discussion of Relevant Art

It is known that the operation and non-operation of an air bag device for a front passenger's seat may be controlled in accordance with the physique of an occupant sitting on the front passenger's seat and the presence or absence of an occupant. For example, the following control is carried out: when an occupant is an adult, the air bag device is operated, and when an occupant is a child or no occupant is sitting on the seat, the air bag device is not operated. Thus, the air bag device can exhibit a restraining performance corresponding to the physique of an occupant, and unnecessary operation can be avoided. Conventionally, the judgment of the physique of an occupant and the presence or absence of an occupant is carried out based on an occupant's weight detected by a weight sensor mounted in a seat (for example, see Japanese Patent Application Laid-open Nos. 10-236274 and 10-297334).

Conventionally, a threshold value for determining the operation or non-operation of the air bag device is a fixed value. If the detected occupant's weight is equal to or larger than the threshold value, the air bag device is operated, and if the detected occupant's weight is smaller than the threshold value, the air bag device is not operated.

When an occupant leans against a dash board, a portion of the weight of the occupant is supported on the dash board, and hence the occupant's weight detected by the weight sensor mounted in the seat may be smaller than an actual weight in some cases. The possibility of such a situation is high, especially when a vehicle is suddenly braked before collision, so that the occupant is moved forwards by an inertia to assume an attitude leaning against the dash board. As a result, even if an actual occupant is an adult having a weight equal to or larger than the threshold value, it is erroneously judged that the occupant is a child, because the weight detected by the weight sensor is smaller than the threshold value. Therefore, there is a possibility that the air bag which should be naturally deployed is not deployed. Such a disadvantage may also be provided when an occupant leans strongly against an armrest.

### SUMMARY OF THE INVENTION

The present invention has been accomplished with such circumstance in view, and it is an object of the present invention to previously prevent a situation in which the occupant's weight is erroneously detected as a value smaller than an actual weight resulting in that the air bag which should be naturally deployed is not deployed.

To achieve the above object, according to the present invention, there is provided an air bag deployment control system comprising a weight sensor which detects weight of an occupant sitting on a seat of a vehicle, and a controller which switches between deployment and non-deployment modes of an air bag based on the occupant weight detected by the weight sensor. The controller switches to the deployment mode permitting deployment of the air bag when the detected weight of the occupant is equal to or larger than a first threshold value, and switches to the non-deployment mode prohibiting deployment of the air bag when the detected weight of the occupant is smaller than a second threshold value. The second threshold value for switching from the deployment mode to the non-deployment mode is set smaller than the first threshold value for switching from the non-deployment mode to the deployment mode.

With the above arrangement, when the following modes are changed from one to the other: deployment mode for permitting the deployment of the air bag when the detected weight of the occupant is equal to or larger than the first threshold value; and the non-deployment mode for prohibiting the deployment of the air bag when the detected weight of the occupant is smaller than the second threshold value, the second threshold value for changing the deployment mode to the non-deployment mode is set to be smaller than the first threshold value for changing the non-deployment mode to the deployment mode. Therefore, when an adult having a weight equal to or larger than the first threshold value is sitting on the seat and the mode is the deployment mode, even if the adult leans against, for example, a dash board so that the detected weight is somewhat reduced, the detected weight does not easily decrease below the second threshold value, because the second threshold value for changing the deployment mode to the non-deployment mode is set to be lower than the first threshold value. Thus, it is possible to reliably avoid a disadvantage in that the air bag is not deployed when the adult is sitting on the seat.

A weight-detecting unit 12 in an embodiment corresponds to the weight sensor of the present invention.

According to another aspect of the invention there is provided an air bag deployment control method in which weight of an occupant sitting on a seat of a vehicle is detected by a weight sensor, the method comprising the steps of switching between deployment and non-deployment modes of an air bag based on the occupant weight detected by the weight sensor,

wherein a switch to the deployment mode which permits deployment of the air bag occurs when the detected weight of the occupant is equal to or larger than a first threshold value, and a switch to the non-deployment mode which prohibits deployment of the air bag occurs when the detected weight of the occupant is smaller than a second threshold value; and the second threshold value for switching the deployment mode to the non-deployment mode is smaller than the first threshold value for switching the non-deployment mode to the deployment mode.

Again the same advantages are achieved as with the first aspect of the invention

### BRIEF DESCRIPTION OF DRAWINGS

FIG. 1 a perspective view of a physique-judging device mounted in a seat according to an embodiment of the present invention.

FIG. 2 is a perspective view of a weight-detecting unit of FIG. 1, as viewed from below.

FIG. 3 is an enlarged sectional view taken along a line 3-3 in FIG. 2.

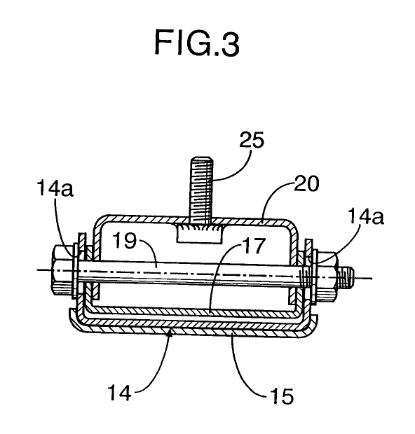

FIG. 4 is a block diagram of a deployment control system for an air bag device.

FIGS. 5A, 5B are diagrams for explaining hysteresis of a first threshold value and a second threshold value.

### DETAILED DESCRIPTION OF THE INVENTION

A mode for carrying out the present invention will now be described by way of an embodiment of the present invention with reference to the accompanying drawings.

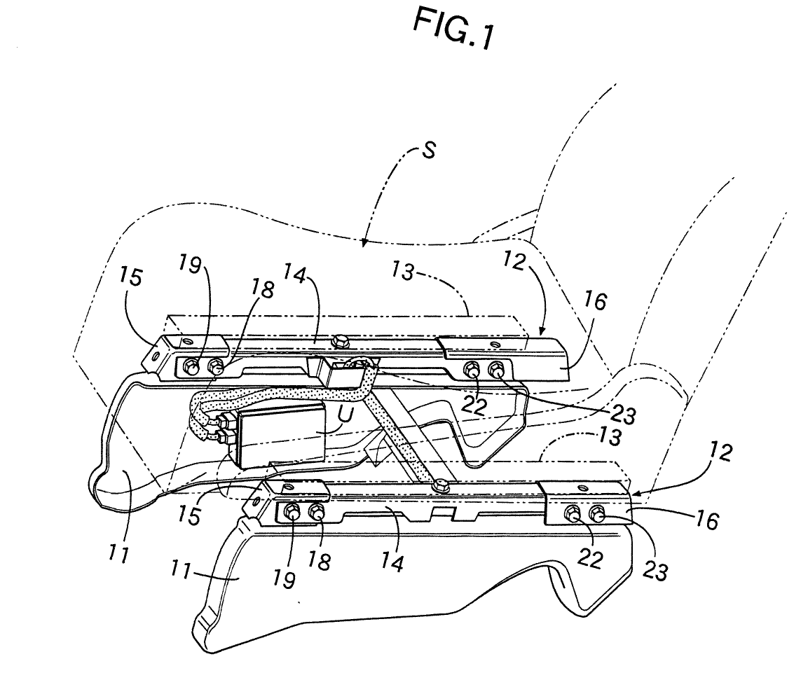

As shown in FIG. 1, a pair of left and right base members 11, 11 are fixed to a floor of an automobile. A pair of left and right weight-detecting units 12, 12 are mounted along upper surfaces of the base members 11, 11. A seat S is longitudinally movably supported on a pair of left and right seat rails 13, 13 fixed to upper surfaces of the weight-detecting units 12, 12.

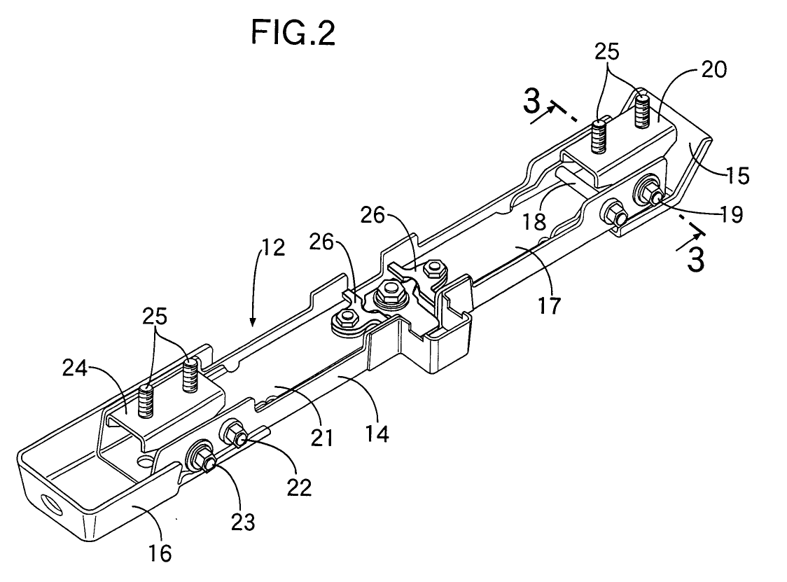

FIG. 2 shows the weight-detecting unit 12 viewed from below. The left and right weight-detecting units 12, 12 have substantially the same structure, and correspondingly only one of the weight-detecting units 12 is shown in FIG. 2.

Each of the weight-detecting units 12 includes a sensor housing 14 having a channel-shape in section with its lower surface opened. Front and rear brackets 15 and 16 are mounted at front and rear ends of the sensor housing 14, respectively. The seat rail 13 is coupled to the brackets 15 and 16. A front arm member 17 is accommodated in a front half of the sensor housing 14, and pivotally supported at a rear location by a pivot pin 18. A front load-receiving member 20 is supported at a front end of the front arm member 17 by a bolt 19. Likewise, a rear arm member 21 is accommodated in a rear half of the sensor housing 14, and pivotally supported at a rear location. A rear load-receiving member 24 is supported at a rear end of the rear arm member 21 by a bolt 23. Both the bolts 19 and 23 are vertically movable mounted to extend through elongated bores 14a formed in the sensor housing 14.

Each of the front and rear brackets 15 and 16 is fixed to the upper surface of the base member 11 by two bolts 25, 25. Two load sensors 26, 26 each comprising a load cell are mounted at a central portion of the sensor housing 14. A rear end of the front arm member 17 and a front end of the rear arm member 21 are connected to the load sensors 26, 26. When the weight of the seat S and the weight of an occupant sitting on the seat S are applied to the four front, rear, left and right load-receiving members 20, 20, 24, 24, the loads on the four load-receiving members 20, 20, 24, 24 cause moments about the pivot pins 18 and 22 to which first ends of four arm members 17, 17, 21, 21 are connected, so that the loads act on the load sensors 26 through the other ends of the four arm members 17, 17, 21, 21. An electronic control unit U is mounted on an inner surface of the right base member 11, and adapted to judge the physique of an occupant sitting on the seat S as well as the presence or absence of an occupant sitting on the seat S based on the loads detected by the load sensors 26.

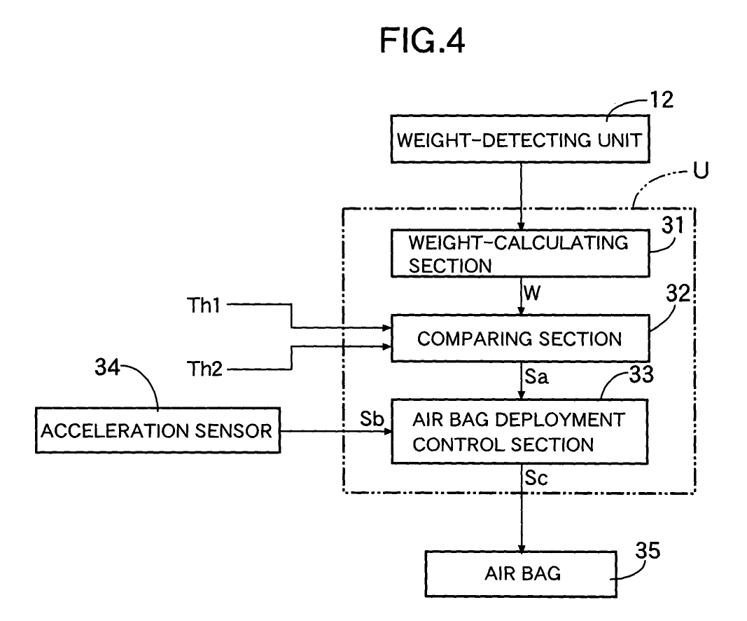

As shown in FIG. 4, the electronic control unit U includes a weight-calculating section 31, and a comparing section 32 and an air bag deployment control section 33. The weight-calculating section 31 calculates an occupant's weight W, for example, by adding outputs from the four front, rear, left and right load sensors 26. The comparing section 32 compares a preset first threshold value Th1 or a preset second threshold value Th2 with the occupant's weight W. If the weight W is equal to or larger than the first threshold value Th1 or the second threshold value Th2, a deployment-permitting signal Sa is output to the air bag deployment control section 33. An acceleration sensor 34 outputs an acceleration signal Sb produced upon collision of the vehicle to the air bag deployment control section 33. When the comparing section 32 has output the deployment-permitting signal Sa and the acceleration signal Sb from the acceleration sensor 34 is equal to or larger than a predetermined threshold value, the air bag deployment control section 33 outputs a deployment command signal Sc to deploy an air bag 35. Thus, only when an occupant is an adult and has a weight W equal to or larger than the first threshold value Th1 or the second threshold value Th2, the air bag 35 is deployed. Therefore, it is possible to appropriately control the deployment of the air bag 35 in accordance with the physique of the occupant sitting on the seat S and the presence or absence of the occupant sitting on the seat S.

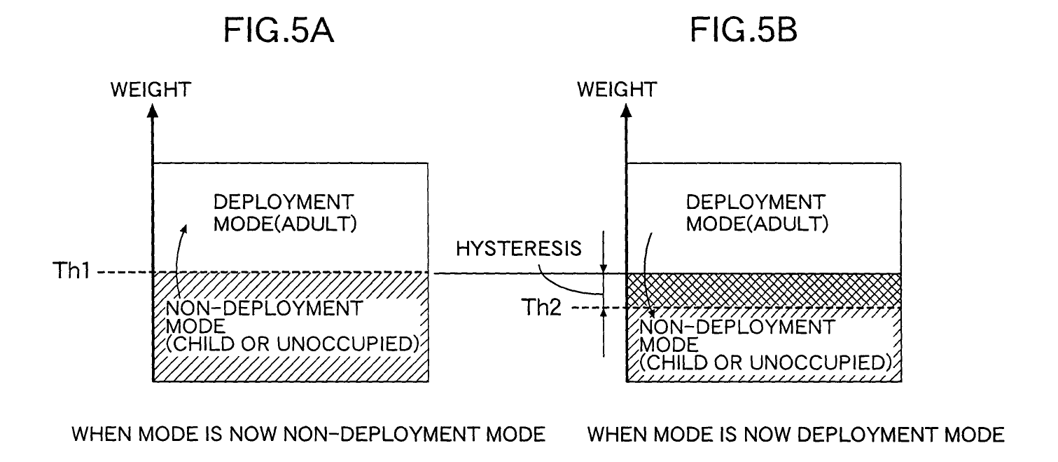

The selection of the first threshold value Th1 or the second threshold value Th2 will be described below with reference to FIGS. 5A, 5B. The first threshold value Th1 is a threshold value based on which the mode is changed from a non-deployment mode (an occupant is a child or unoccupied) to a deployment mode (an occupant is an adult), as shown in FIG. 5A. The second threshold value Th2 is a threshold value based on which the mode is changed from the deployment mode (the occupant is the adult) to the non-deployment mode (the occupant is the child or unoccupied), as shown in FIG. 5B. The second threshold value Th2 is set to be lower than the first threshold value Th1. Also shown in FIG. 5B is a hysteresis of the first and second threshold values.

Therefore, when an adult having a weight W equal to or larger than the first threshold value Th1 is sitting on the seat S and the mode is the deployment mode, even if the adult leans against, for example, a dash board so that the detected weight W is reduced, the weight W does not easily decrease below the second threshold value Th2, because the second threshold value Th2 for changing the mode from the deployment mode to the non-deployment mode is set to be lower than the first threshold value Th1. Thus, it is possible to avoid in advance a disadvantage in that the air bag 35 is not deployed when an adult is sitting on the seat S.

Although the embodiment of the present invention has been described in detail, it will be understood that various modifications may be made without departing from the subject matter of the present invention.

For example, in the embodiment, the occupant's weight W is calculated by adding the outputs from the four load sensors 26, but the outputs from the four load sensors 26 for calculating the occupant's weight W may be processed as desired.

As discussed above, according to the present invention, when the following modes are changed from one to the other: deployment mode for permitting the deployment of the air bag when the detected weight of the occupant is equal to or larger than the first threshold value; and the non-deployment mode for prohibiting the deployment of the air bag when the detected weight of the occupant is smaller than the second threshold value, the second threshold value for changing the deployment mode to the non-deployment mode is set to be smaller than the first threshold value for changing the non-deployment mode to the deployment mode. Therefore, when an adult having a weight equal to or larger than the first threshold value is sitting on the seat and the mode is the deployment mode, even if the adult leans against, for example, a dash board so that the detected weight is somewhat reduced, the detected weight does not easily decrease below the second threshold value, because the second threshold value for changing the deployment mode to the non-deployment mode is set to be lower than the first threshold value. Thus, it is possible to reliably avoid a disadvantageous situation in which the air bag is not deployed when the adult is sitting on the seat.

What is claimed is:

1. An air bag deployment control system, comprising:
a weight sensor which detects weight of an occupant sitting on a seat of a vehicle; and
a controller which switches between deployment and non-deployment modes of an air bag based on the occupant weight detected by the weight sensor;
wherein the controller switches to the deployment mode permitting deployment of the air bag when the detected weight of the occupant is equal to or larger than a first threshold value and switches to the non-deployment mode prohibiting deployment of the air bag when the detected weight of the occupant is smaller than a second threshold value; and
the second threshold value for switching from the deployment mode to the non-deployment mode is set smaller than the first threshold value for switching from the non-deployment mode to the deployment mode.

2. The air bag deployment control system according to claim 1, further including an acceleration sensor which detects an acceleration of the vehicle, and said controller further controls deployment and non-deployment of the air bag based on the detected acceleration of the vehicle.

3. The air bag deployment control system according to claim 1, including a plurality of said weight sensors which detect the weight of the occupant sitting on the seat, and the controller which switches between deployment and non-deployment modes of an air bag based on the occupant weight collectively detected by the weight sensors.

4. The air bag deployment control system according to claim 1, wherein said weight sensor is disposed beneath a sliding rail of the seat.

5. An air bag deployment control method in which weight of an occupant sitting on a seat of a vehicle is detected by a weight sensor, the method comprising the steps of:
switching between deployment and non-deployment modes of an air bag based on the occupant weight detected by the weight sensor;
wherein a switch to the deployment mode which permits deployment of the air bag occurs when the detected weight of the occupant is equal to or larger than a first threshold value, and a switch to the non-deployment mode which prohibits deployment of the air bag occurs when the detected weight of the occupant is smaller than a second threshold value; and
the second threshold value for switching the deployment mode to the non-deployment mode is smaller than the first threshold value for switching the non-deployment mode to the deployment mode.

6. The air bag deployment control method according to claim 5, the vehicle includes an acceleration sensor which detects an acceleration of the vehicle, and deployment and non-deployment of the air bag is further based on the detected acceleration of the vehicle.

7. The air bag deployment control method according to claim 5, wherein the vehicle includes a plurality of said weight sensors which detect the weight of the occupant sitting on the seat, and the switching between deployment and non-deployment modes of an air bag is based on the occupant weight collectively detected by the weight sensors.
